(19) United States
(12) Patent Application Publication
(10) Pub. No.: US 2007/0119020 A1
(43) Pub. Date: May 31, 2007

(54) Devices for selectively inhibiting the closure of doors and methods for inhibiting the closure of doors

(75) Inventor: Jeri Homa Keating, Port Orchard, WA (US)

Correspondence Address: PERKINS COIE LLP;PATENT-SEA, P.O. BOX 1247, SEATTLE, WA, 98111-1247, US

(73) Assignee: DigitSaver, LLC, Port Orchard, WA (US)

(21) Appl. No.: 11/606,609

(22) Filed: Nov. 29, 2006

Related U.S. Application Data
(60) Provisional application No. 60/740,959, filed on Nov. 30, 2005.

(51) Int. Cl. E05B 1/00

(52) U.S. Cl. 16/110.1

(57) ABSTRACT

Devices for selectively inhibiting the closure of doors, methods of manufacturing such devices, and methods of installing such devices are disclosed herein. The doors can include a distal surface and a handle proximate to the distal surface. In one embodiment, a device includes a first portion configured to be removably attached to the handle of the door, and a second portion projecting from the first portion. The second portion is sized and configured to be positioned at the distal surface of the door to inhibit closure of the door.

### CROSS-REFERENCE TO RELATED APPLICATION

This application claims the benefit of U.S. Provisional Patent Application No. 60/740,959, filed Nov. 30, 2005, which is incorporated by reference herein.

### TECHNICAL FIELD

The present disclosure is directed to devices for selectively inhibiting the closure of doors, methods of manufacturing such devices, and methods of installing such devices.

### BRIEF DESCRIPTION OF THE DRAWINGS

FIGS. 1A-1F are schematic views of a device for selectively inhibiting the closure of doors in accordance with one embodiment of the invention.

FIG. 2 is a schematic view of a device for inhibiting the closure of doors in accordance with another embodiment of the invention.

### DETAILED DESCRIPTION

### A. Overview

The following disclosure describes several embodiments of devices for selectively inhibiting the closure of doors, methods of manufacturing such devices, and methods of installing such devices. One aspect of the invention is directed to devices for inhibiting closure of a door. The door has a distal surface and a handle proximate to the distal surface. In one embodiment, a device includes a first portion configured to be removably attached to the handle of the door, and a second portion projecting from the first portion. The second portion is sized and configured to be positioned at the distal surface of the door to inhibit closure of the door.

In another embodiment, a device includes a base configured to be removably attached to the handle of the door, and a projecting portion projecting from the base a distance sufficient to project beyond the distal surface of the door when the base is attached to the handle of the door.

Another aspect of the invention is directed to methods for inhibiting closure of doors. In one embodiment, a method includes releasably attaching a first portion of a device to a handle assembly at a first side of a door such that a second portion of the device is positioned at a distal surface of the door and inhibits closure of the door. The method further includes releasably coupling an extensible portion of the device to the handle assembly at a second side of the door.

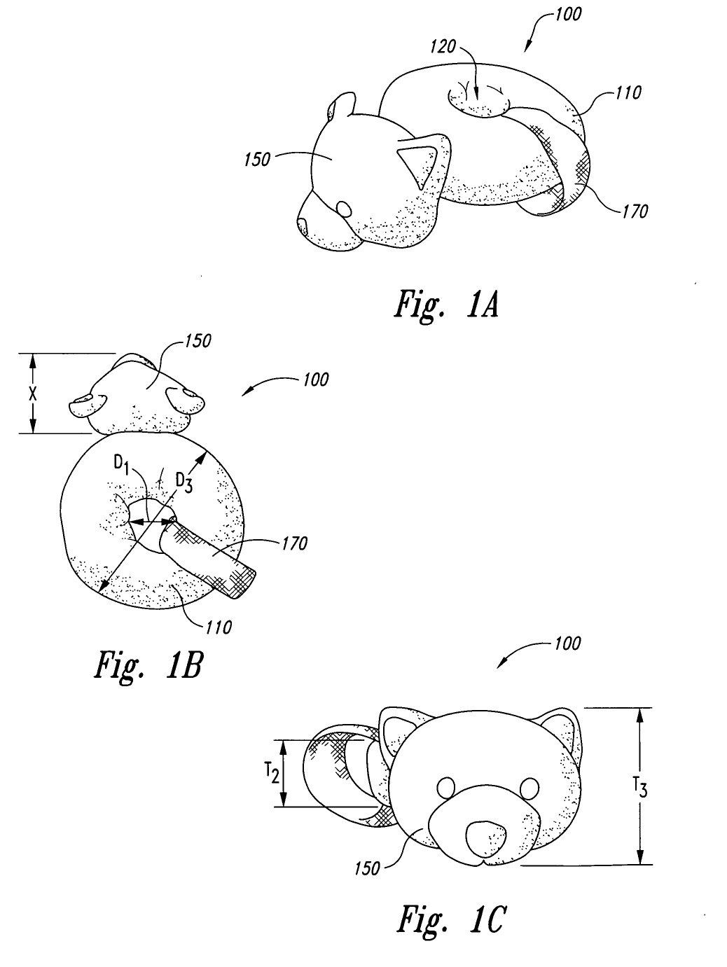

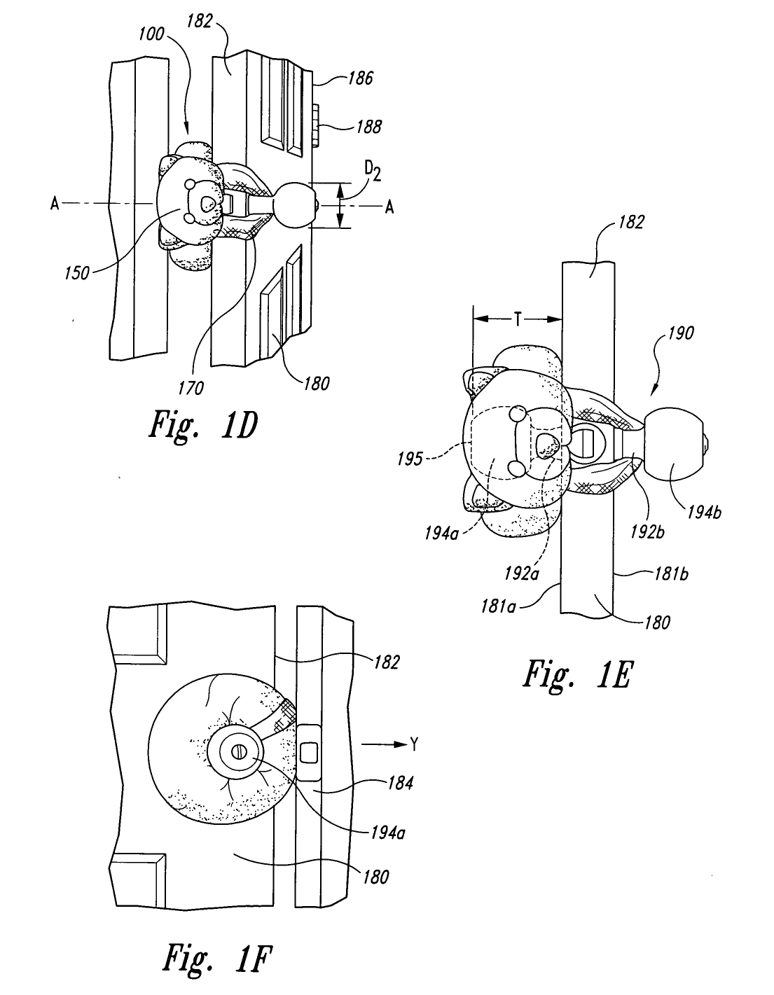

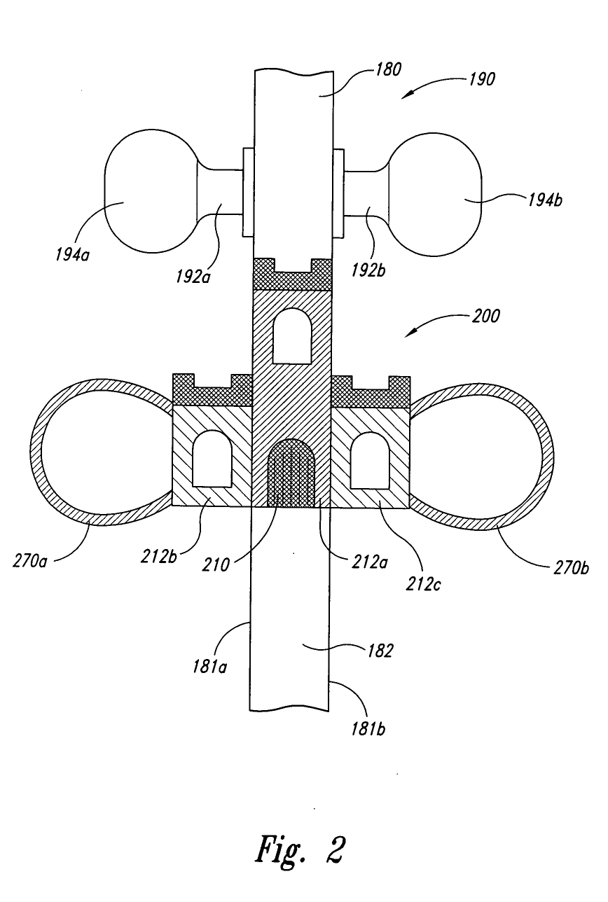

Specific details of several embodiments of the invention are described below with reference to devices for selectively inhibiting the closure of doors, methods of manufacturing such devices, and methods of installing such devices. Several details describing well-known structures or processes often associated with doors and door handle assemblies are not set forth in the following description for purposes of brevity and clarity. Also, several other embodiments of the invention can have different configurations, components, or procedures than those described in this section. A person of ordinary skill in the art, therefore, will accordingly understand that the invention may have other embodiments with additional elements, or the invention may have other embodiments without several of the elements shown and described below with reference to FIGS. 1A-2.

Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same features and/or other types of features and components are not precluded.

### B. Embodiments of Devices for Selectively Inhibiting the Closure of Doors

FIGS. 1A-1F illustrate a device 100 for selectively inhibiting the closure of a door 180 in accordance with one embodiment of the invention. The particular door 180 illustrated in FIGS. 1A-1F includes a first major surface 181a, a second major surface 181b opposite the first major surface 181a, a distal surface 182 extending between the first and second major surfaces 181a-b, a proximal surface 184 extending between the first and second major surfaces 181a-b, and a door handle assembly 190 at the distal surface 182. The distal surface 182 is opposite the proximal surface 184, and the proximal surface 184 is pivotably coupled to a door jamb 186 with a plurality of hinges 188. The illustrated door handle assembly 190 includes a first neck 192a projecting from the first surface 181a, a first knob 194a attached to the first neck 192a, a second neck 192b projecting from the second surface 181b, and a second knob 194b attached to the second neck 192b. The first neck 192a and the first knob 194a project a distance T₁ from the first surface 181a of the door 180. Although the device 100 illustrated in FIGS. 1A-1F will be discussed in conjunction with the illustrated door handle assembly 190, in other embodiments the device 100 can be used with other door handle assemblies, including assemblies with a cantilevered handle or lever rather than a knob.

The device 100 is removably attached to the door handle assembly 190 for selectively inhibiting the closure of the door 180 such that the door 180 remains at least partially ajar. The illustrated device 100 includes a base 110 and a projecting portion 150 projecting from the base 110. The base 110 is configured to be slid onto and carried by the first neck 192a and the first knob 194b of the door handle assembly 190. For example, the illustrated base 110 is made of a deformable material and has a generally annular shape with (a) a thickness T₂ that is less than the distance T₁ the first neck 192a and the first knob 194a project from the first surface 181a, and (b) a through aperture 120 with a first diameter D₁. The first diameter D₁ of the aperture 120 is sized so that when the base 110 is stretched, the first diameter D₁ is greater than a major diameter D₂ of the first knob 194a so that the first knob 194a can be inserted into the aperture 120 and the device 100 can be installed on the door handle assembly 190. When the device 100 is installed and the base 110 at least partially returns to its unstretched state, the first diameter D₁ is smaller than the major diameter D₂ of the first knob 194a such that the device 100 remains attached to the door handle assembly 190. The device 100 can be subsequently removed from the door handle assembly 190 by stretching the base 110 and sliding the first knob 194a back through the aperture 120. In the illustrated embodiment, the first diameter D₁ of the aperture 120 is also sized to allow the device 100 to pivot about an axis A-A defined by the first neck 192a and the first knob 194b. The illustrated base 110 further includes an outer diameter D₂ sized so that the base 110 does not contact the door jamb 186 when the door 180 is closed. In other embodiments, however, the outer diameter D₂ may be sized so that the base 110 contacts the door jamb 186 and prevents the door 180 from closing. In additional embodiments, the device 100 may not pivot about the axis A-A.

In other embodiments, the base 110 can have other configurations. For example, the base 110 can have a rectangular, triangular, or other suitable shape. Moreover, the base 110 may include a blind hole in lieu of the aperture 120 such that the portion of the base 110 at the bottom of the blind hole contacts a distal surface 195 of the first knob 194a. Furthermore, in additional embodiments, all or a portion of the base 110 may not be made of a deformable material.

The projecting portion 150 projects from the base 110 and is configured to inhibit the closure of the door 180. Specifically, in the illustrated embodiment, the projecting portion 150 is non-removably attached to the base 110 and projects a distance X in a direction generally transverse to an axis defined by the aperture 120. The distance X is sufficient such that the projecting portion 150 projects beyond the distal surface 182 of the door 180 when the projecting portion 150 is oriented in a direction Y as illustrated in FIGS. 1D-1F. In such a position, the projecting portion 150 contacts the door jamb 186 and prevents the door 180 from completely closing when the door 180 is moved toward the closed position. In other embodiments, the projecting portion 150 can be an integral part of the base 110. Alternatively, the device 100 may not include a projecting portion 150, but rather the outer diameter D₃ of the base 110 can be sized to inhibit the closure of the door 180. Moreover, although the illustrated projecting portion 150 is configured to resemble a cat's head, in other embodiments, the projecting portion can have other configurations and/or shapes. For example, the projecting portion can resemble the head of a bear, pig, or dog.

The illustrated device 100 is pivotable between (a) a first position (shown in FIGS. 1D-1F) in which the projecting portion 150 projects beyond the distal surface 182 of the door 180, and (b) a second position (not shown) in which the projecting portion 150 projects upward, downward, or toward the proximal surface 184 of the door 180, but not beyond the distal surface 182 of the door 180. In the first position, the device 100 prevents the door 180 from completely closing because the projecting portion 150 is positioned to contact the door jamb 186 before the door 180 is completely closed. Specifically, the projecting portion 150 inhibits further movement of the door 180 toward the closed position because the portion 150 is positioned between the door 180 and the door jamb 186. In the second position, the projecting portion 150 is positioned so as not to contact the door jamb 186 so that the door 180 can be completely closed. As a result, a user can pivot the device 100 between the first and second positions to selectively prevent the door 180 from closing or allow the door 180 to close as desired.

The device 100 illustrated in FIGS. 1A-1F further includes an extensible strap or band 170 for selectively retaining the device 100 in the first or second position. The band 170 extends through the aperture 120 and can be wrapped around the second neck 192b and/or the second knob 194b of the door handle assembly 190 when the device 100 is installed. After installation, the band 170 exerts a force on the base 110 to inhibit the base 110 from pivoting about the axis A-A. The band 170, however, allows a user to selectively pivot the device 100 between the first and second positions to either inhibit the door 180 from closing or allow the door 180 to close. The band 170 can be made of a relatively thin elastic material so that the portion of the band 170 extending across the distal surface 182 of the door 180 does not contact the door jamb 186 and/or does not inhibit the door 180 from closing. In other embodiments, the device 100 may not include the band 170, but rather some other mechanism for retaining the device 100 in the first or second position. For example, the base 110 can be made of an elastic material and the first diameter D₁ can be sized to prevent accidental rotation of the device 100.

In the illustrated embodiment, the base 110 and the projecting portion 150 include a flexible enclosure (e.g., a fabric) and compressible filler material in the enclosure (e.g., stuffed with cotton batting). In other embodiments, however, the base 110 and/or the projecting portion 150 can be made of plastic, latex, rubber, and/or other suitable materials. Moreover, although the illustrated device 100 resembles a cat, in additional embodiments, the device 100 may resemble other animals, characters, and/or other objects. For example, the device 100 can resemble cartoon characters.

One feature of the device 100 illustrated in FIGS. 1A-1F is that the device 100 selectively prevents an individual from completely closing the door 180. An advantage of this feature is that the device 100 prevents children and/or other individuals from closing the door 180 on their fingers and pinching or otherwise injuring (e.g., severing) their fingers between the door 180 and the door jamb 186. Moreover, the device 100 also inhibits children and/or other individuals from accidentally locking themselves in a room. As described above, a parent or other person may selectively pivot the device 100 to the first position for inhibiting closure of a door.

Another feature of the device 100 illustrated in FIGS. 1A-1F is that the device 100 can pivot about the door handle assembly 190 between a first position in which the device 100 inhibits closure of the door 180 and a second position in which the door 180 can be closed. An advantage of this feature is that the device 100 does not need to be removed from the door 180 to allow an individual to close the door 180. As a result, the illustrated device 100 is easier and more convenient to use than conventional devices that must be removed from a door in order to close the door. Furthermore, the illustrated device 100 is less likely to be lost or misplaced because it does not need to be removed from a door and stowed in another location like conventional devices.

Another feature of the illustrated device 100 is that the base 110 and the projecting portion 150 are made of generally deformable materials. An advantage of this feature is that the device 100 is expected to inhibit the closure of a door without marking, denting, and/or otherwise damaging the door, door hinges, and/or door jamb when an individual attempts to close the door and the projecting portion contacts the door jamb.

Another feature of the device 100 illustrated in FIGS. 1A-1F is that the base 110 can be securely and removably attached to the door handle assembly 190. An advantage of this feature is that the device 100 is expected to remain on and not fall off the door handle assembly 190 when an individual attempts to close the door 180. Although the device 100 is expected to remain on the door 180, a person can intentionally remove the device 100 from the door handle assembly 190.

FIG. 2 is a schematic view of a device 200 for selectively inhibiting the closure of the door 180 in accordance with another embodiment of the invention. For illustrative purposes, the device 200 is shown detached and shifted downward from the door handle assembly 190 in FIG. 2. The illustrated device 200 includes a base 210, a first extensible strap or band 270a attached to the base 210, and a second extensible strap or band 270b attached to the base 210. The base 210 is configured to be positioned at the distal surface 182 of the door 180 to inhibit the closure of the door 180. The first and second bands 270 are configured to be releasably attached to the door handle assembly 190 to retain the device 200 on the door 180. The illustrated base 210 includes a first section 212a, a second section 212b, and a third section 212c. The first, second, and third sections 212a-c can be generally flexible so that when the device 200 is attached to the door 200, the first section 212a is positioned against the distal surface 182, the second section 212b is positioned against the first major surface 181a, and the third section 212c is positioned against the second major surface 181b. Although the illustrated base 210 has a castle-like configuration, in additional embodiments the base 210 can have other configurations. For example, the base 210 can have configuration corresponding to an animal (e.g., a bee), airplane, car, boat, cartoon character, or other object.

The first band 270a is attached to the second section 212b of the base 210, and the second band 270b is attached to the third section 212c of the base 210. The first and second bands 270a-b can be stretched and placed around the first and second necks 192a-b, respectively, of the door handle assembly 190. The first and second bands 270a-b accordingly retain the device 200 on the door 180 during use. In other embodiments, the first and/or second band 270a-b can have a different configuration. For example, one or both of the first and second bands 270a-b may not be extensible.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, although the illustrated devices are shaped to resemble an animal and a castle, various other shapes are possible.

The teachings of the invention provided herein can be applied to other door and door handle assembly configurations. These and other changes can be made to the invention in light of the detailed description. The elements and acts of the various embodiments described above can be combined to provide further embodiments. Aspects of the invention can be modified, if necessary, to employ the systems, functions, and concepts of the various examples described above and illustrated in the figures to provide yet further embodiments of the invention.

These and other changes can be made to the invention in light of the above detailed description. While the above description details certain embodiments of the invention and describes the best mode contemplated, no matter how detailed the above appears in text, the invention can be practiced in many ways. Details of the device for inhibiting closure of a door may vary considerably in its implementation details, while still being encompassed by the invention disclosed herein. For example, many of the details, dimensions, angles, and other features shown in the figures are merely illustrative of particular embodiments of the invention. Accordingly, other embodiments can have other details, dimensions, and/or features without departing from the spirit or scope of the present invention.

From the foregoing, it will be appreciated that specific embodiments of the invention have been described herein for purposes of illustration, but that various modifications may be made without deviating from the invention. Furthermore, aspects of the invention described in the context of particular embodiments may be combined or eliminated in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A device for inhibiting closure of a door, the door having a distal surface and a handle proximate to the distal surface, the device comprising:
a first portion configured to be removably attached to the handle of the door; and
a second portion projecting from the first portion, the second portion being sized and configured to be positioned at the distal surface of the door to inhibit closure of the door.

2. The device of claim 1 wherein:
the first portion comprises a first flexible enclosure and first compressible filler material in the first enclosure;
the second portion comprises a second flexible enclosure and second compressible filler material in the second enclosure;
the first portion has an annular configuration with an aperture sized to receive the handle;
the first portion is non-removably attached to the second portion; and
the device further comprises an extensible band coupled to the first portion.

3. The device of claim 1 wherein:
the first portion comprises an extensible member; and
the second portion comprises a flexible enclosure and compressible filler material in the enclosure.

4. The device of claim 1 wherein:
the first portion comprises a first flexible enclosure and first compressible filler material in the first enclosure; and
the second portion comprises a second flexible enclosure and second compressible filler material in the second enclosure.

5. The device of claim 1 wherein the first portion has an annular configuration with an aperture sized to receive the handle.

6. The device of claim 1, further comprising an extensible band coupled to the first portion.

7. The device of claim 1 wherein the first portion is non-removably attached to the second portion.

8. The device of claim 1 wherein:
the first portion is configured to be removably attached to a first handle projecting from a first surface of the door; and
the device further comprises a third portion configured to be removably attached to a second handle projecting from a second surface of the door.

9. The device of claim 1 wherein:
the first portion comprises a compressible material and has an annular configuration with an aperture;
the aperture has a first diameter less than a major diameter of the handle when the first portion is in a generally unstretched state; and
the aperture has a second diameter greater than the major diameter of the handle when the first portion is in a stretched state.

10. A device for inhibiting closure of a door, the door having a distal surface and a handle proximate to the distal surface, the device comprising:
a base configured to be removably attached to the handle of the door; and
a projecting portion projecting from the base a distance sufficient to project beyond the distal surface of the door when the base is attached to the handle of the door.

11. The device of claim 10 wherein the base is configured to selectively pivot relative to the handle of the door such that the projecting portion is movable between (a) a first position in which the projecting portion projects beyond the distal surface of the door and inhibits closure of the door, and (b) a second position in which the projecting portion does not project beyond the distal surface of the door and does not inhibit closure of the door.

12. The device of claim 10, further comprising an extensible band coupled to the base.

13. The device of claim 10 wherein the base has an annular configuration with an aperture sized to receive a knob of the door.

14. The device of claim 10 wherein the base and the projecting portion comprise a deformable material.

15. A method for inhibiting closure of a door, the method comprising:
releasably attaching a first portion of a device to a handle assembly at a first side of a door such that a second portion of the device is positioned at a distal surface of the door and inhibits closure of the door; and
releasably coupling an extensible portion of the device to the handle assembly at a second side of the door.

16. The method of claim 15 wherein releasably attaching the first portion of the device comprises inserting a handle of the handle assembly into an aperture in the first portion of the device.

17. The method of claim 15 wherein releasably coupling the extensible portion of the device to the handle assembly comprises positioning an extensible strap around a handle of the handle assembly.

18. The method of claim 15 wherein releasably attaching the first portion of the device comprises positioning the second portion of the device such that the second portion projects beyond the distal surface of the door and inhibits closure of the door.

19. The method of claim 15, further comprising pivoting the first portion of the device between (a) a first position in which the second portion projects beyond the distal surface of the door and inhibits closure of the door, and (b) a second position in which the second portion does not project beyond the distal surface of the door and does not inhibit closure of the door.

20. The method of claim 15 wherein the second portion comprises a flexible enclosure and compressible filler material in the enclosure.
